(19) United States
(12) Patent Application Publication
(10) Pub. No.: US 2023/0020937 A1
(43) Pub. Date: Jan. 19, 2023

(54) IMAGE PROCESSING METHOD, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Yizhou LIU, Beijing (CN); Dingchao YANG, Beijing (CN)

(21) Appl. No.: 17/952,619

(22) Filed: Sep. 26, 2022

Related U.S. Application Data
(63) Continuation of application No. PCT/CN2020/139133, filed on Dec. 24, 2020.

(30) Foreign Application Priority Data
Jun. 19, 2020 (CN) 202010567699.5

(51) Int. Cl. G06V 40/16; G06T 7/90; G06T 3/40; G06T 11/40

(52) U.S. Cl. CPC G06V 40/168; G06T 7/90; G06T 3/40; G06T 11/40; G06T 2207/30201

(57) ABSTRACT

An image processing method includes: determining a first face mask image that does not contain hair from a target image, and obtaining a first face region that does not contain hair from the target image according to the first face mask image; filling a preset grayscale color outside the first face region to generate an image to be sampled; performing down-sampling on the image to be sampled to obtain sampling results, and obtaining remaining sampling results by removing one or more sampling results in which a color is the preset grayscale color from the sampling results; obtaining a target color by calculating a mean color value of the remaining sampling results and performing weighted summation on a preset standard face color and the mean color value; rendering pixels in a face region of the target image according to the target color.

### CROSS-REFERENCE TO RELATED APPLICATION

The present application is a continuation application of International Application No. PCT/CN2020/139133, filed Dec. 24, 2020, which is based upon and claims priority to Chinese Patent Application No. 202010567699.5, filed Jun. 19, 2020, the entire contents of which are incorporated herein by reference.

### FIELD

The present disclosure relates to the technical field of image processing, and more particularly to an image processing method, an image processing device, an electronic device, and a storage medium.

### BACKGROUND

In an image processing application, processing of facial features of a human face, such as enlargement, dislocation or erasure, are common operations. However, the current erasure operation generally results in a poor rendering effect due to a large difference between a color intended to replace the facial feature and a color of the human face. In addition, there are generally a large number of pixels near facial organs, so the calculation amount is large, which makes a device with a small computing power unapplicable.

### SUMMARY

The present disclosure provides an image processing method, an image processing device, an electronic device and a storage medium to solve problems existing in the related art to at least some extent.

According to a first aspect of examples of the present disclosure, an image processing method is provided. The method includes: determining a first face mask image that does not contain hair from a target image, and obtaining a first face region that does not contain hair from the target image according to the first face mask image; filling a preset grayscale color in the target image outside the first face region to generate an image to be sampled in a preset shape; performing down-sampling on the image to be sampled to obtain sampling results, and obtaining one or more remaining sampling results by removing one or more sampling results in which a color is the preset grayscale color from the sampling results; obtaining a target color by calculating a mean color value of the one or more remaining sampling results and performing weighted summation on a preset standard face color and the mean color value; performing rendering on pixels in a face region of the target image according to the target color.

According to a second aspect of examples of the present disclosure, an image processing device is provided. The image processing device includes: a first face determination module configured to determine a first face mask image that does not contain hair from a target image, and obtain a first face region that does not contain hair from the target image according to the first face mask image; an image generation module configured to fill a preset grayscale color in the target image outside the first face region to generate an image to be sampled in a preset shape; a down-sampling module configured to perform down-sampling on the image to be sampled to obtain sampling results, and obtain one or more remaining sampling results by removing one or more sampling results in which a color is the preset grayscale color from the sampling results; a calculation module configured to obtain a target color by calculating a mean color value of the one or more remaining sampling results and performing weighted summation on a preset standard face color and the mean color value; a rendering module configured to perform rendering on pixels in a face region of the target image according to the target color.

According to a third aspect of examples of the present disclosure, an electronic device is provided. The electronic device includes a processor, and a memory for storing instructions executable by the processor. The processor is configured to execute the instructions to perform the above-mentioned image processing method.

According to a fourth aspect of examples of the present disclosure, a storage medium is provided. The storage medium has stored therein instructions that, when executed by a processor of an electronic device, cause the electronic device to perform the above-mentioned image processing method.

According to a fifth aspect of examples of the present disclosure, a computer program product is provided. The program product includes a computer program, and the computer program is stored in a readable storage medium. The computer program, when read from the readable storage medium and executed by at least one processor of a device, cause the device to perform the above-mentioned image processing method.

It should be understood that both the above general description and the following detailed description are explanatory and illustrative and shall not be construed to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the present disclosure, and do not constitute an improper limitation of the present disclosure.

FIG. 1 is a schematic flow chart of an image processing method according to an example of the present disclosure.

FIG. 2 is a schematic diagram showing a first face mask image according to an example of the present disclosure.

FIG. 3 is a schematic diagram showing an image to be sampled according to an example of the present disclosure.

FIG. 4 is a schematic diagram showing sampling results according to an example of the present disclosure.

FIG. 5 is a schematic diagram showing a color corresponding to a mean color value according to an example of the present disclosure.

FIG. 6 is a schematic diagram showing a target color according to an example of the present disclosure.

FIG. 7 is a schematic flow chart of an image processing method according to an example of the present disclosure.

FIG. 8 is a schematic flow chart of an image processing method according to an example of the present disclosure.

FIG. 9 is a schematic flow chart of an image processing method according to an example of the present disclosure.

FIG. 10 is a schematic flow chart of an image processing method according to an example of the present disclosure.

FIG. 11 is a schematic diagram showing a second face region after rendered according to an example of the present disclosure.

FIG. 12 is a schematic flow chart of an image processing method according to an example of the present disclosure.

FIG. 13 is a schematic block diagram showing an image processing device according to an example of the present disclosure.

FIG. 14 is a schematic block diagram showing a calculation module according to an example of the present disclosure.

FIG. 15 is a schematic block diagram showing a calculation module according to an example of the present disclosure.

FIG. 16 is a schematic block diagram showing a rendering module according to an example of the present disclosure.

FIG. 17 is a schematic block diagram showing a rendering module according to an example of the present disclosure.

FIG. 18 is a schematic block diagram showing a rendering module according to an example of the present disclosure.

FIG. 19 is a schematic block diagram of an electronic device according to an example of the present disclosure.

### DETAILED DESCRIPTION

In order to make those ordinarily skilled in the art better understand the technical solutions of the present disclosure, examples of the present disclosure will be described clearly and thoroughly below with reference to the accompanying drawings.

It should be noted that the terms like “first” and “second” as used in the specification, claims and the accompanying drawings of the present disclosure are intended to distinguish similar objects, but not intended to describe a specific order or sequence. It should be understood that the terms so used may be interchangeable where appropriate, such that examples of the present disclosure described herein may be implemented in a sequence other than those illustrated or described herein. The embodiments described in the following illustrative examples are not intended to represent all embodiments consistent with the present disclosure. On the contrary, they are merely examples of devices and methods consistent with some aspects of the present disclosure as recited in the appended claims.

FIG. 1 is a schematic flow chart of an image processing method according to an example of the present disclosure. The image processing method as illustrated in examples of the present disclosure is applicable to a terminal, such as a mobile phone, a tablet computer, a wearable device, a personal computer and so on, and also applicable to a server, such as a local server, a cloud server, and so on.

As shown in FIG. 1, the image processing method includes steps as follows.

In S101, a first face mask image that does not contain hair is determined from a target image, and a first face region that does not contain hair is obtained from the target image according to the first face mask image.

In S102, a preset grayscale color is filled in the target image outside the first face region to generate an image to be sampled in a preset shape.

In S103, down-sampling is performed on the image to be sampled to obtain sampling results, and one or more sampling results in which a color is the preset grayscale color are removed from the sampling results to obtain one or more remaining sampling results.

In S104, a target color is obtained by calculating a mean color value of the one or more remaining sampling results and performing weighted summation on a preset standard face color and the mean color value.

In S105, rendering is performed on pixels in a face region of the target image according to the target color.

In some examples, the ways for determining the first face mask image may be selected as required. For example, a mask determination model may be obtained through training with deep learning in advance, and the mask determination model is configured to determine a mask image that does not contain hair from an image, so that with the mask determination model, the first face mask image that does not contain the hair may be determined from the target image. For example, a key point determination model may be obtained through training with deep learning in advance, and the key point determination model is configured to determine key points on a face in the image, so that with the key point determination model, key points on a face in the target image may be determined, and a closed region formed by connecting the key points at an periphery of the face is determined as the first face mask image.

After the first face mask image is determined, the first face region that does not contain the hair may be obtained from the target image according to the first face mask image, and the preset grayscale color is filled in the target image outside the first face region to generate the image to be sampled in the preset shape. The preset grayscale may be selected between 0 and 255 as required. For example, when the preset grayscale is 0, the preset grayscale color is black; when the preset grayscale is 255, the preset grayscale color is white. In examples of the present disclosure, a color with a preset grayscale of 0 or a color with a preset grayscale of 255 may be selected, which is beneficial to avoid the occurrence of the case where a sampling result including face pixels is removed due to its same color as the preset grayscale color in subsequent sampling processes.

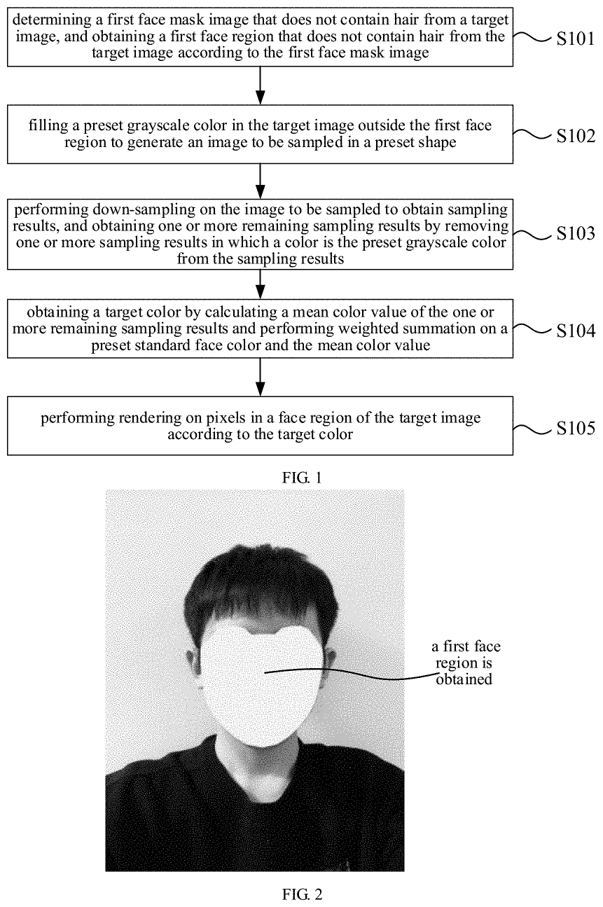

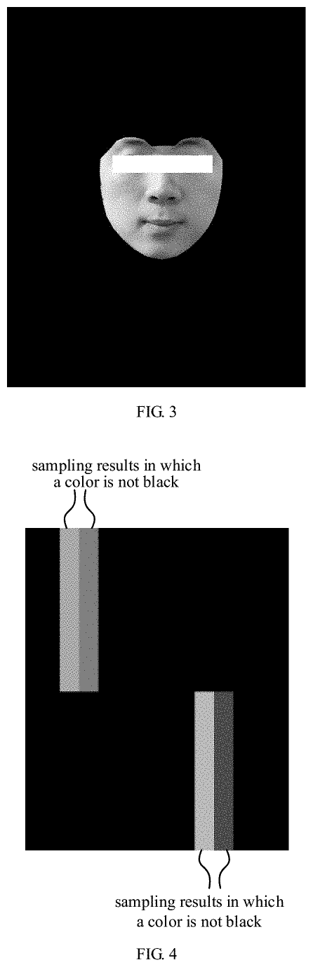

FIG. 2 is a schematic diagram showing a first face mask image according to an example of the present disclosure. FIG. 3 is a schematic diagram showing an image to be sampled according to an example of the present disclosure.

Take a case where the preset grayscale is 0 and the preset grayscale color is black as an example. The first face region that does not contain the hair as shown in FIG. 3 may be obtained from the target image according to the first face mask image as shown in FIG. 2, and the preset grayscale color is filled in the target image outside the first face region to form the preset shape, which may be a rectangle as shown in FIG. 3 or other shapes, which is not limited by the present disclosure.

The image to be sampled may be subjected to down-sampling. The down-sampling process may be set as required, such as set to be 4*7 which indicates that sampling is performed 4 times in a width direction and 7 times in a height direction to obtain 28 sampling results. In each time of sampling, a single pixel may be sampled, or a plurality of pixels near a certain position may be sampled. Alternatively, the image to be sampled may be divided into 4*7 regions on average, and a mean color value of pixels in each region is determined as the sampling result.

In general, a large area of pure preset grayscale color does not appear on the human skin, so the sampling result in which the color is the preset grayscale color is completely obtained through sampling on a part that is filled with the preset grayscale color and outside the first face region, and does not contain a skin color for reference. Therefore, the sampling result in which the color is the preset grayscale color may be removed from the sampling results, and thus the remaining sampling results contain skin colors for reference.

FIG. 4 is a schematic diagram showing sampling results according to an example of the present disclosure.

As shown in FIG. 4, there are two lines of sampling results, and each line contains 14 sampling results, so there are 28 sampling results in total. Among the 28 sampling results, there are 24 sampling results whose color is the preset grayscale color and 4 sampling results whose color is not the preset grayscale color, so the 24 sampling results whose color is the preset grayscale color may be removed, and the 4 sampling results whose color is not the preset grayscale color are retained.

There may be one or more remaining sampling results. In the case of one remaining sampling result, its color value is used as a mean color value. In the case of more than one remaining sampling results, a mean color value of color values of these remaining sampling results may be calculated. A color for example may be expressed by a grayscale value of 0 to 255, or may be expressed by a value in an interval of 0 to 1 which is converted from the grayscale value of 0 to 255.

Although the color of the remaining sampling result is not the preset grayscale color, the remaining sampling result may be obtained from a sampling area which contains both a region filled with the preset grayscale color and the face region, which will result in a darker mean color. In some cases, the target image is obtained in an extreme environment, such as in a dark light environment, so the color of each remaining sample will be darker, which also result in a darker mean color.

In view of the above-mentioned situations, in embodiments of the present disclosure, after the mean color value of the one or more remaining sampling results is calculated, weighted summation may be further performed on the preset standard face color and the mean color value to obtain the target color. The standard face color may be a preset color close to a face skin color. By performing the weighted summation on the preset standard face color and the mean color value of the one or more remaining sampling results, the mean color value of the one or more remaining sampling results may be corrected to a certain extent based on the standard face color, which avoids that the color obtained only based on the mean color value is greatly different from a normal face color.

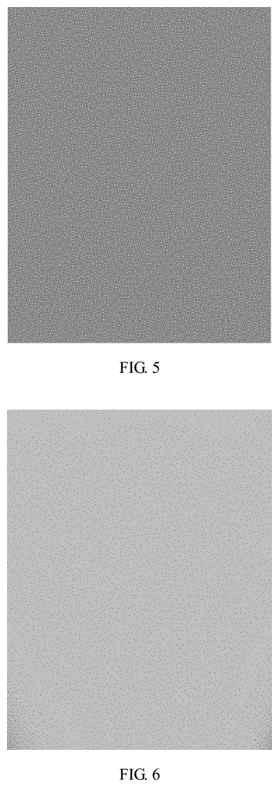

FIG. 5 is a schematic diagram showing a color corresponding to a mean color value according to an example of the present disclosure. FIG. 6 is a schematic diagram showing a target color according to an example of the present disclosure. As shown in FIG. 5, the color corresponding to the mean color value is darker, while the target color obtained by weighted summation on the preset standard face color and the mean color value, as shown in FIG. 6, is closer to the human face skin color, so that not only the face color in the target image can be reflected by the mean color value, but also the obtained target color will not be largely different from the normal face color.

Finally, the pixels in the face region of the target image may be rendered according to the target color, such that the colors of all pixels in the face region may be set as the target color, thereby erasing the facial features of eyes, eyebrows, nose, mouth and the like in the face region.

According to examples of the present disclosure, the target color is obtained by performing down-sampling, because the data amount of color information in the sampling results obtained by the down-sampling is relatively small, so it can be processed conveniently by a device with small computing power. In addition, the target color for rendering is obtained by weighted summation on the preset standard face color and the mean color value, so that the mean color value may reflect the face color in the target image, and the standard face color may play a corrective role.

Examples of the present disclosure not only enable the target color to match the face color in the target image, but also avoid the large difference between the target color and the normal face color.

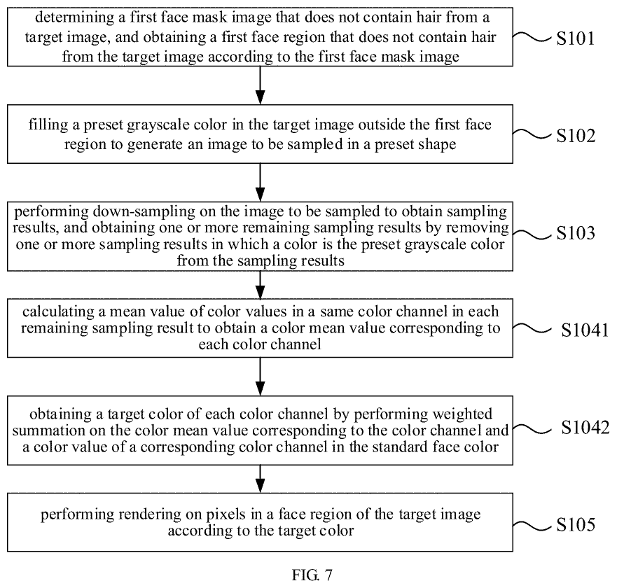

FIG. 7 is a schematic flow chart of an image processing method according to an example of the present disclosure. As shown in FIG. 7, the obtaining the target color by calculating the mean color value of the one or more remaining sampling results and performing weighted summation on the preset standard face color and the mean color value includes steps as follows.

In S1041, a mean value of color values in a same color channel in each remaining sampling result is calculated to obtain a mean color value corresponding to each color channel.

In S1042, weighted summation is performed on the mean color value corresponding to each color channel and a color value of a corresponding color channel in the standard face color to obtain a target color of the color channel.

In some examples, the remaining sampling result may include color values of a plurality of color channels, such as three color channels including an R (red) channel, a G (green) channel and a B (blue) channel. A color of each color channel may be expressed by a grayscale value of 0 to 255, or expressed by a value in an interval of 0 to 1 which is converted from the grayscale value of 0 to 255. For the one or more remaining sampling results, the mean value of the color values of the same color channel in each remaining sampling result may be calculated to obtain the mean color value corresponding to each color channel.

The standard face colors also includes colors of the three color channels. In the case where the colors of the three color channels of the remaining sampling result are expressed by values in the interval of 0 to 1, then the colors of the three color channels of the standard face color may also be expressed by values in the interval of 0 and 1. For example, the standard face color may be set as (0.97, 0.81, 0.7). Weighted summation may be performed on the mean color value corresponding to each color channel and the color value of the corresponding color channel in the standard face color to obtain the target color of the color channel.

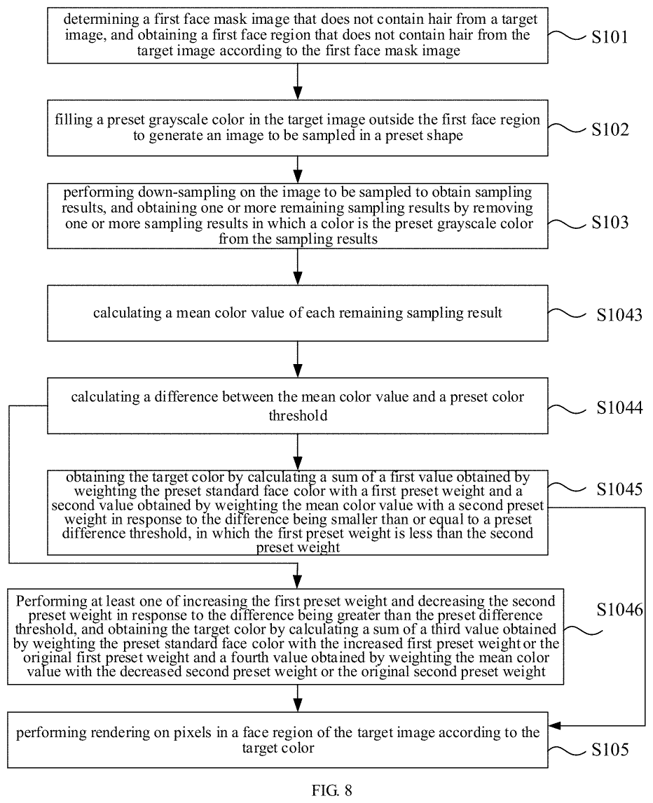

FIG. 8 is a schematic flow chart of an image processing method according to an example of the present disclosure. As shown in FIG. 8, the obtaining the target color by calculating the mean color value of the one or more remaining sampling results and performing weighted summation on the preset standard face color and the mean color value includes steps as follows.

In S1043, a mean color value of each remaining sampling result is calculated.

In S1044, a difference between the mean color value and a preset color threshold is calculated.

In such case, the target color may be obtained by performing weighted summation on the preset standard face color and the mean color value based on the difference.

In some examples, said obtaining the target color by performing weighted summation on the preset standard face color and the mean color value based on the difference includes at least one of the following operations as described below in S1045 and S1046.

In S1045, in response to the difference being smaller than or equal to a preset difference threshold, a sum of a first value obtained by weighting the preset standard face color with a first preset weight and a second value obtained by weighting the mean color value with a second preset weight is calculated to obtain the target color. The first preset weight is less than the second preset weight.

In S1046, in response to the difference being greater than the preset difference threshold, at least one of the following operations is performed: increasing the first preset weight and decreasing the second preset weight, and a sum of a third value obtained by weighting the preset standard face color with the increased first preset weight or the original first preset weight and a fourth value obtained by weighting the mean color value with the decreased second preset weight or the original second preset weight is calculated to obtain the target color.

In some examples, for the weighted summation on the preset standard face color and the mean color value, the weight of the mean color value and the weight of the preset standard face may be set in advance, or may be adjusted in real time.

For example, the color threshold may be preset for comparison with the obtained mean color value. The preset color threshold may be a color value that is close to the skin color value in general. Specifically, the difference between the mean color value and the preset color threshold value may be calculated.

If the difference is smaller than or equal to the preset difference threshold, it means that the obtained mean color value is relatively close to the skin color in general. In this case, the preset standard face color may be weighted with the first preset weight to obtain the first value, the mean color value may be weighted with the second preset weight to obtain the second value, and the sum of the first value and the second value is calculated to obtain the target color. Since the second preset weight is greater than the first preset weight, the target color obtained by weighted summation may reflect the face skin color in the target image to a greater extent, ensuring that the rendering result is close to an original color of the face skin in the target image.

If the difference is greater than the preset difference threshold, it means that the obtained mean color value is quite different from the skin color in general, and the face in the target image may be in a relatively extreme environment, resulting in the obtained mean color value being relatively abnormal. In this case, the first preset weight may be increased, or the second preset weight may be decreased, or the first preset weight may be increased, and at the same time the second preset weight is decreased, the preset standard face color is weighted with the increased first preset weight or the original first preset weight to obtain the third value, the mean color value is weighted with the decreased second preset weight or the original second preset weight to obtain the fourth value, and the sum of the third value and the fourth value is calculated to obtain the target color. By decreasing the second preset weight and increasing the first preset weight, the influence of the abnormal mean color value on the target color may be reduced, and the correction effect of the standard face color may be strengthened.

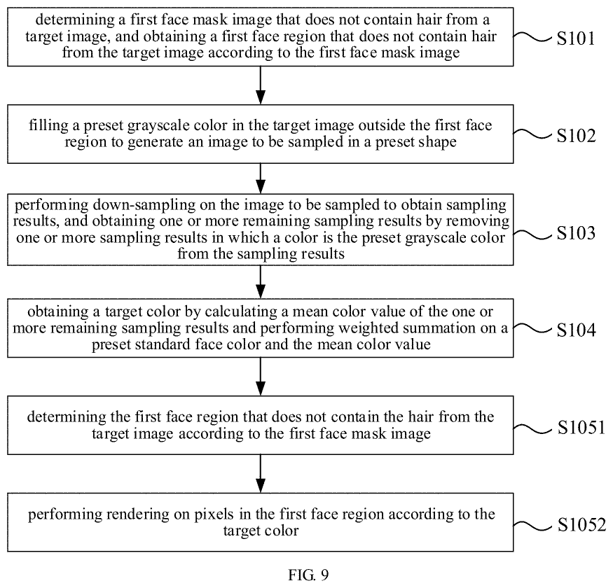

FIG. 9 is a schematic flow chart of an image processing method according to an example of the present disclosure. As shown in FIG. 9, the performing rendering on the pixels in the face region of the target image according to the target color includes steps as follows.

In S1051, the first face region that does not contain the hair is determined from the target image according to the first face mask image.

In S1052, rendering is performed on pixels in the first face region according to the target color.

In some examples, the first face region that does not contain the hair may be determined from the target image according to the first face mask image, and then the rendering may be performed on the pixels in the first face region according to the target color. In this way, the colors of all pixels in the face region are set as the target color, and the effect of erasing the facial features such as eyes, eyebrows, nose, and mouth in the face region is realized.

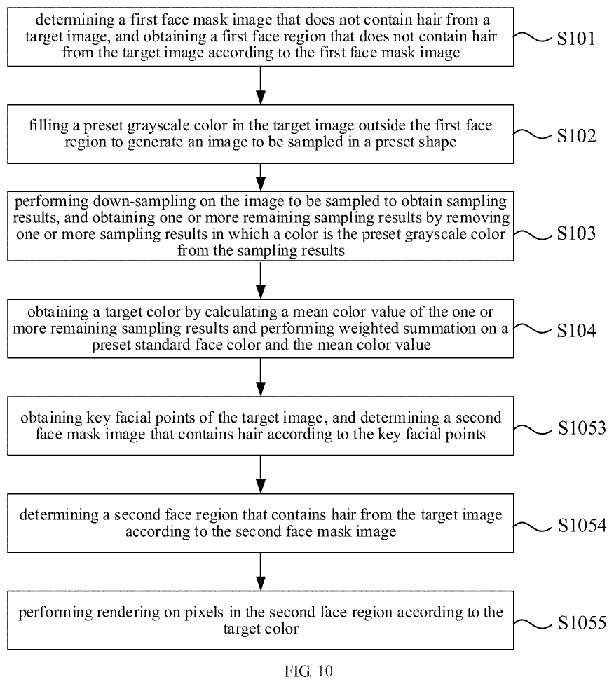

FIG. 10 is a schematic flow chart of an image processing method according to an example of the present disclosure. As shown in FIG. 10, the performing rendering on the pixels in the face region of the target image according to the target color includes steps as follows.

In S1053, key facial points of the target image are obtained, and a second face mask image that contains hair is determined according to the key facial points.

In S1054, a second face region that contains hair is determined from the target image according to the second face mask image.

In S1055, rendering is performed on pixels in the second face region according to the target color.

Based on the example shown in FIG. 9, rendering is performed on the pixels in the first face region. Since the first face region does not contain the hair, there will be a clear boundary at a junction between the first face region and the hair, which is unnatural for the user to watch.

In this example, the key facial points of the target image may be obtained, the second face mask image that contains the hair may be determined according to the key facial points, and the second face region that contains the hair may be determined from the target image according to the second face mask map. Since the second face region contains the hair, there is no clear boundary between the second face region and the hair, and thus rendering the pixels in the second face region according to the target color may obtain a relatively natural rendering result.

FIG. 11 is a schematic diagram showing a second face region after rendered according to an example of the present disclosure.

As shown in FIG. 11, the second face mask image may be approximately oval, which covers the chin to the forehead from top to bottom and covers the left periphery of the face to the right periphery of the face from left to right. The second face region contains the hair, so there is no clear boundary between the hair and the forehead, such that rendering the pixels in the second face region according to the target color may obtain a relatively natural rendering result.

Further, during rendering, it is also possible to gradually decrease the rendering effect on the periphery of the second face region, such that the second face region after rendered has a certain degree of transparency, thereby achieving a good transition relative to a region other than the face region in visual.

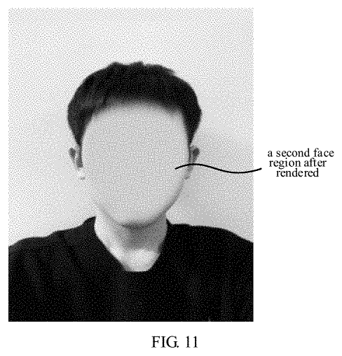

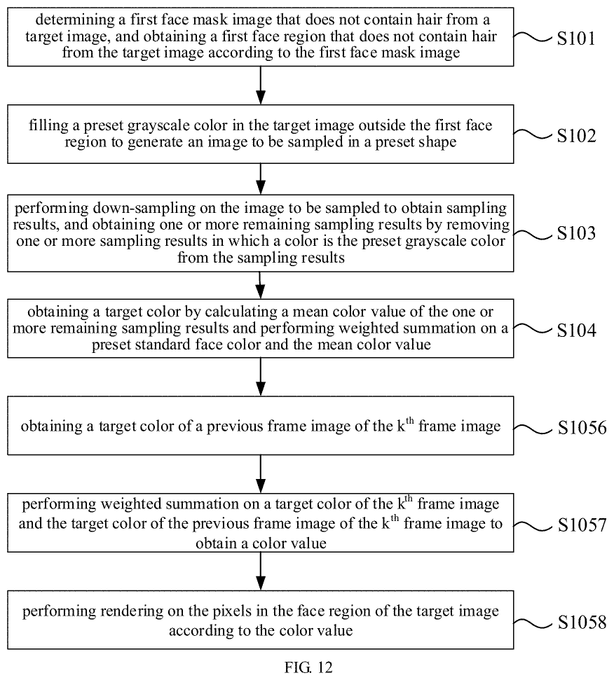

FIG. 12 is a schematic flow chart of an image processing method according to an example of the present disclosure. As shown in FIG. 12, the target image is a k^{th} frame image in consecutive multi-frame images, and k is an integer greater than 1. The performing rendering on the pixels in the face region of the target image according to the target color includes steps as follows.

In S1056, a target color of a previous frame image of the k^{th} frame image is obtained.

In S1057, weighted summation is performed on a target color of the k^{th} frame image and the target color of the previous frame image of the k^{th} frame image to obtain a color value.

In S1058, rendering is performed on the pixels in the face region of the target image according to the color value.

In some examples, the target image may be a single image, or may be a k^{th} frame image in consecutive multi-frame images, such as a certain frame image of a video.

Since a light of an environment where the face is located may change, or an angle between the face and a light source may change, so the face skin color among the multi-frame images also will change. If the pixels in the face region are rendered only according to the target color corresponding to the target image, the rendering results of adjacent images may be quite different from each other, and the user may feel that the color of the face region after the facial features are erased jumps or flickers.

For this, examples of the present disclosure may follow the steps as described in the example shown in FIG. 12 to obtain and store the target color of the previous frame image of the k^{th} frame image, perform weighted summation on the target color of the k^{th} frame image and the target color of the previous frame image of the k^{th} frame image to obtain a color value, which combines the face color in the k^{th} frame image and the face color of the previous frame image of the k^{th} frame image, and render the pixels in the face region of the target image according to the color value, thereby avoiding the color jump of the face region in the rendering result relative to the image before the k^{th} frame image (for example, the previous frame image).

Corresponding to the above-mentioned examples of the image processing methods, the present disclosure also provides some examples of image processing devices.

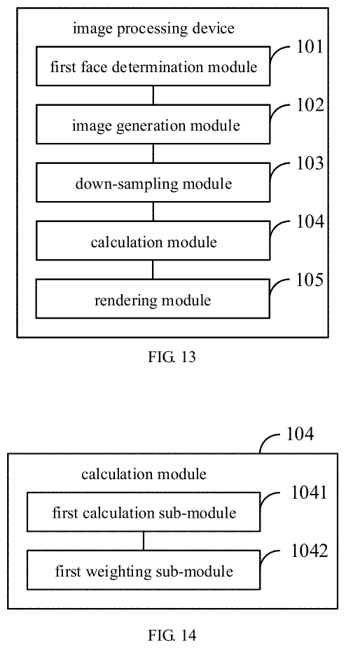

FIG. 13 is a schematic block diagram showing an image processing device according to an example of the present disclosure. The image processing device shown in the example is applicable to a terminal, such as a mobile phone, a tablet computer, a wearable device, a personal computer and so on, and is also applicable to a server, such as a local server, a cloud server, and so on.

As shown in FIG. 13, the image processing device may include:

a first face determination module 101 configured to determine a first face mask image that does not contain hair from a target image, and obtain a first face region that does not contain hair from the target image according to the first face mask image;

an image generation module 102 configured to fill a preset grayscale color in the target image outside the first face region to generate an image to be sampled in a preset shape;

a down-sampling module 103 configured to perform down-sampling on the image to be sampled to obtain sampling results, and obtain one or more remaining sampling results by removing one or more sampling results in which a color is the preset grayscale color from the sampling results;

a calculation module 104 configured to obtain a target color by calculating a mean color value of the one or more remaining sampling results and performing weighted summation on a preset standard face color and the mean color value; and

a rendering module 105 configured to perform rendering on pixels in a face region of the target image according to the target color.

FIG. 14 is a schematic block diagram showing a calculation module according to an example of the present disclosure. As shown in FIG. 14, the calculation module 104 includes:

a first calculation sub-module 1041 configured to calculate a mean value of color values in a same color channel in each remaining sampling result to obtain a mean color value corresponding to each color channel; and

a first weighting sub-module 1042 configured to obtain a target color of each color channel by performing weighted summation on the mean color value corresponding to the color channel and a color value of a corresponding color channel in the standard face color.

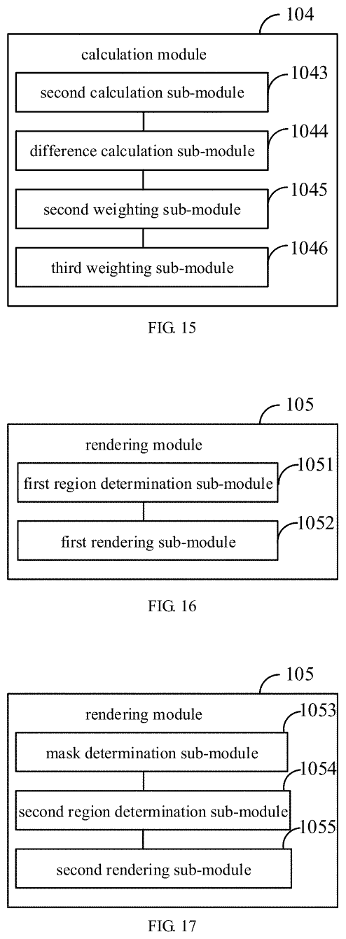

FIG. 15 is a schematic block diagram showing a calculation module according to an example of the present disclosure. As shown in FIG. 15, the calculation module 104 includes:

a second calculation sub-module 1043 configured to calculate a mean color value of each remaining sampling result;

a difference calculation sub-module 1044 configured to calculate a difference between the mean color value and a preset color threshold;

a second weighting sub-module 1045 configured to obtain the target color by calculating a sum of a first value obtained by weighting the preset standard face color with a first preset weight and a second value obtained by weighting the mean color value with a second preset weight in response to the difference being smaller than or equal to a preset difference threshold, in which the first preset weight is less than the second preset weight; and

a third weighting sub-module 1046 configured to perform at least one of increasing the first preset weight and decreasing the second preset weight in response to the difference being greater than the preset difference threshold, and obtain the target color by calculating a sum of a third value obtained by weighting the preset standard face color with the increased first preset weight or the original first preset weight and a fourth value obtained by weighting the mean color value with the decreased second preset weight or the original second preset weight.

FIG. 16 is a schematic block diagram showing a rendering module according to an example of the present disclosure. As shown in FIG. 16, the rendering module 105 includes:

a first region determination sub-module 1051 configured to determine the first face region that does not contain the hair from the target image according to the first face mask image; and

a first rendering sub-module 1052 configured to perform rendering on pixels in the first face region according to the target color.

FIG. 17 is a schematic block diagram showing a rendering module according to an example of the present disclosure. As shown in FIG. 17, the rendering module 105 includes:

a mask determination sub-module 1053 configured to obtain key facial points of the target image, and determine a second face mask image that contains hair according to the key facial points;

a second region determination sub-module 1054 configured to determine a second face region that contains hair from the target image according to the second face mask image; and

a second rendering sub-module 1055 configured to perform rendering on pixels in the second face region according to the target color.

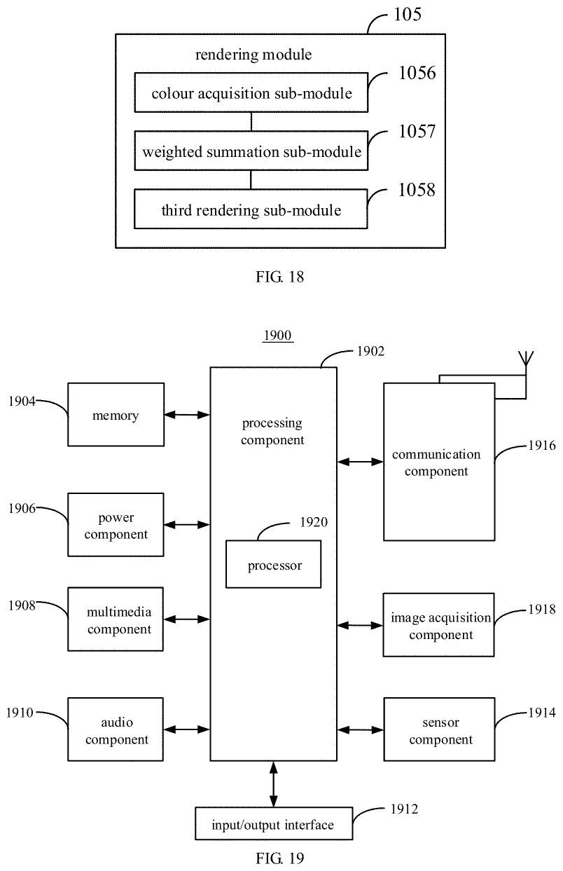

FIG. 18 is a schematic block diagram showing a rendering module according to an example of the present disclosure. As shown in FIG. 18, the target image is a k^{th} frame image in consecutive multi-frame images, and k is an integer greater than 1, and the rendering module 105 includes:

a color acquisition sub-module 1056 configured to obtain a target color of a previous frame image of the k^{th} frame image;

a weighted summation sub-module 1057 configured to perform weighted summation on a target color of the k^{th} frame image and the target color of the previous frame image of the k^{th} frame image to obtain a color value; and

a third rendering sub-module 1058 configured to perform rendering on the pixels in the face region of the target image according to the color value.

In some examples of the present disclosure, there is provided an electronic device. The electronic device includes a processor, and a memory for storing instructions executable by the processor. The processor is configured to execute the instructions to perform the above-mentioned image processing method as described in any embodiment hereinbefore.

In some examples of the present disclosure, there is provided a storage medium. The storage medium has stored therein instructions that, when executed by a processor of an electronic device, cause the electronic device to perform the above-mentioned image processing method as described in any embodiment hereinbefore.

In some examples of the present disclosure, there is provided a computer program product. The program product includes a computer program, and the computer program is stored in a readable storage medium. The computer program, when read from the readable storage medium and executed by at least one processor of a device, causes the device to perform the above-mentioned image processing method as described in any embodiment hereinbefore.

FIG. 19 is a schematic block diagram of an electronic device according to an example of the present disclosure. For example, the electronic device 1900 may be a mobile phone, a computer, a digital broadcast terminal, a messaging device, a game console, a tablet device, a medical device, a fitness device, a personal digital assistant, and the like.

Referring to FIG. 19, the electronic device 1900 may include one or more of the following components: a processing component 1902, a memory 1904, a power component 1906, a multimedia component 1908, an audio component 1910, an input/output (I/O) interface 1912, a sensor component 1914, and a communication component 1916.

The processing component 1902 typically controls overall operations of the electronic device 1900, such as operations associated with display, telephone calls, data communications, camera operations, and recording operations. The processing component 1902 may include one or more processors 1920 to execute instructions to perform all or part of the steps in the above described image processing method. Moreover, the processing component 1902 may include one or more modules which facilitate interaction between the processing component 1902 and other components. For instance, the processing component 1902 may include a multimedia module to facilitate interaction between the multimedia component 1908 and the processing component 1902.

The memory 1904 is configured to store various types of data to support the operation of the electronic device 1900. Examples of such data include instructions for any applications or methods operated on the electronic device 1900, contact data, phonebook data, messages, pictures, videos, etc. The memory 1904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 1906 provides power to various components of the electronic device 1900. The power component 1906 may include a power management system, one or more power sources, and any other components associated with the generation, management, and distribution of power in the electronic device 1900.

The multimedia component 1908 includes a screen providing an output interface between the electronic device 1900 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some examples, the multimedia component 1908 includes a front camera and/or a rear camera. The front camera and the rear camera may receive external multimedia data while the electronic device 1900 is in an operation mode, such as a photographing mode or a video mode. Each of the front camera and the rear camera may be a fixed optical lens system or have focus and optical zoom capability.

The audio component 1910 is configured to output and/or input audio signals. For example, the audio component 1910 includes a microphone (MIC) configured to receive an external audio signal when the electronic device 1900 is in an operation mode, such as a call mode, a recording mode, and a voice recognition mode. The received audio signal may be further stored in the memory 1904 or transmitted via the communication component 1916. In some examples, the audio component 1910 further includes a speaker to output audio signals.

The I/O interface 1912 provides an interface between the processing component 1902 and a peripheral interface module, such as a keyboard, a click wheel, buttons, and the like. The buttons may include, but are not limited to, a home button, a volume button, a starting button, and a locking button.

The sensor component 1914 includes one or more sensors to provide status assessments of various aspects of the electronic device 1900. For instance, the sensor component 1914 may detect an open/closed status of the electronic device 1900, relative positioning of components, e.g., the display and the keyboard, of the electronic device 1900, a change in position of the electronic device 1900 or a component of the electronic device 1900, a presence or absence of user contact with the electronic device 1900, an orientation or an acceleration/deceleration of the electronic device 1900, and a change in temperature of the electronic device 1900. The sensor component 1914 may include a proximity sensor configured to detect a presence of nearby objects without any physical contact. The sensor component 1914 may also include a light sensor, such as a CMOS or CCD image sensor, for use in imaging applications. In some examples, the sensor component 1914 may also include an accelerometer sensor, a gyroscope sensor, a magnetic sensor, a pressure sensor, or a temperature sensor.

The communication component 1916 is configured to facilitate communication, wired or wireless, between the electronic device 1900 and other devices. The electronic device 1900 may access a wireless network based on a communication standard, such as WiFi, an operator network (such as 2G, 3G, 4G or 5G) or a combination thereof. In some examples, the communication component 1916 receives a broadcast signal or broadcast associated information from an external broadcast management system via a broadcast channel. In some examples, the communication component 1916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some examples of the present disclosure, the electronic device 1900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described image processing methods.

In some examples of the present disclosure, there is also provided a non-transitory computer-readable storage medium including instructions, such as the memory 1904 including instructions, and the instructions are executable by the processor 1920 in the electronic device 1900 for performing the above-described image processing methods. For example, the non-transitory computer-readable storage medium may be a read-only memory (ROM), a random access memory (RAM), a CD-ROM, a magnetic tape, a floppy disc, an optical data storage device, and the like.

Other embodiments of the present disclosure will be apparent to those skilled in the art from consideration of the specification and practice of the present disclosure disclosed herein. The present disclosure is intended to cover any variations, uses, or adaptive modifications of the present disclosure following the general principles thereof and including common knowledge or conventional techniques in the art not disclosed by this disclosure. It is intended that the specification and examples are considered as explanatory only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

It is noted that relationship terms such as first and second are only used herein to distinguish an entity or operation from another entity or operation, and it is not necessarily required or implied that there are any actual relationship or order of this kind between those entities and operations. Moreover, terms such as “comprise”, “include” and any other variants are intended to cover non-exclusive inclusions, so that the processes, methods, articles or devices including a series of elements not only include those elements but also include other elements that are not listed definitely, or also include the elements inherent in the processes, methods, articles or devices. In the case of no more restrictions, the element defined by the statement “comprising a/an . . . ” does not exclude the existence of other same elements in the processes, methods, articles or devices including that element.

The method and device provided by examples of the present disclosure are described in detail above. In the disclosure, specific examples are used to explain the principles and implementations of the present disclosure. The description of the above examples is only used to help understand the method and core idea of the present disclosure, and for those skilled in the art, according to the idea of the present disclosure, changes can be made in the specific implementation modes and application scopes. To sum up, the content of the specification should not be understood as a limitation of the present disclosure.

What is claimed is:

1. An image processing method, comprising:
determining a first face mask image that does not contain hair from a target image, and obtaining a first face region that does not contain hair from the target image according to the first face mask image;
filling a preset grayscale color in the target image outside the first face region to generate an image to be sampled in a preset shape;
performing down-sampling on the image to be sampled to obtain sampling results, and obtaining one or more remaining sampling results by removing one or more sampling results in which a color is the preset grayscale color from the sampling results;
obtaining a target color by calculating a mean color value of the one or more remaining sampling results and performing weighted summation on a preset standard face color and the mean color value;
performing rendering on pixels in a face region of the target image according to the target color.

2. The method according to claim 1, wherein said obtaining the target color by calculating the mean color value of the one or more remaining sampling results and performing weighted summation on the preset standard face color and the mean color value comprises:
calculating a mean value of color values in a same color channel in each remaining sampling result to obtain a mean color value corresponding to each color channel;
obtaining a target color of each color channel by performing weighted summation on the mean color value corresponding to the color channel and a color value of a corresponding color channel in the standard face color.

3. The method according to claim 1, wherein said obtaining the target color by calculating the mean color value of the one or more remaining sampling results and performing weighted summation on the preset standard face color and the mean color value comprises:
calculating a mean color value of each remaining sampling result;
calculating a difference between the mean color value and a preset color threshold; and
obtaining the target color by performing weighted summation on the preset standard face color and the mean color value based on the difference.

4. The method according to claim 3, wherein said obtaining the target color by performing weighted summation on the preset standard face color and the mean color value based on the difference comprises at least one of:
obtaining the target color by calculating a sum of a first value obtained by weighting the preset standard face color with a first preset weight and a second value obtained by weighting the mean color value with a second preset weight in response to the difference being smaller than or equal to a preset difference threshold, wherein the first preset weight is less than the second preset weight; and
performing at least one of increasing the first preset weight and decreasing the second preset weight in response to the difference being greater than the preset difference threshold, and obtaining the target color by calculating a sum of a third value obtained by weighting the preset standard face color with the increased first preset weight or the original first preset weight and a fourth value obtained by weighting the mean color value with the decreased second preset weight or the original second preset weight.

5. The method according to claim 1, wherein said performing rendering on the pixels in the face region of the target image according to the target color comprises:
determining the first face region that does not contain the hair from the target image according to the first face mask image;
performing rendering on pixels in the first face region according to the target color.

6. The method according to claim 1, wherein said performing rendering on the pixels in the face region of the target image according to the target color comprises:
obtaining key facial points of the target image, and determining a second face mask image that contains hair according to the key facial points;
determining a second face region that contains hair from the target image according to the second face mask image;
performing rendering on pixels in the second face region according to the target color.

7. The method according to claim 1, wherein the target image is a k^{th} frame image in consecutive multi-frame images, and k is an integer greater than 1; and said performing rendering on the pixels in the face region of the target image according to the target color comprises:
obtaining a target color of a previous frame image of the k^{th} frame image;
performing weighted summation on a target color of the k^{th} frame image and the target color of the previous frame image of the k^{th} frame image to obtain a color value;
performing rendering on the pixels in the face region of the target image according to the color value.

8. An electronic device, comprising:
a processor; and
a memory for storing instructions executable by the processor;
wherein the processor is configured to execute the instructions to:
determine a first face mask image that does not contain hair from a target image, and obtain a first face region that does not contain hair from the target image according to the first face mask image;
fill a preset grayscale color in the target image outside the first face region to generate an image to be sampled in a preset shape;
perform down-sampling on the image to be sampled to obtain sampling results, and obtain remaining one or more sampling results by removing one or more sampling results in which a color is the preset grayscale color from the sampling results;
obtain a target color by calculating a mean color value of the one or more remaining sampling results and performing weighted summation on a preset standard face color and the mean color value;
perform rendering on pixels in a face region of the target image according to the target color.

9. The electronic device according to claim 8, wherein the processor is configured to execute the instructions to:
calculate a mean value of color values in a same color channel in each remaining sampling result to obtain a mean color value corresponding to each color channel;
obtain a target color of each color channel by performing weighted summation on the mean color value corresponding to the color channel and a color value of a corresponding color channel in the standard face color.

10. The electronic device according to claim 8, wherein the processor is configured to execute the instructions to:
calculate a mean color value of each remaining sampling result;
calculate a difference between the mean color value and a preset color threshold; and
obtain the target color by performing weighted summation on the preset standard face color and the mean color value based on the difference.

11. The electronic device according to claim 10, wherein the processor is configured to execute the instructions to:
obtain the target color by calculating a sum of a first value obtained by weighting the preset standard face color with a first preset weight and a second value obtained by weighting the mean color value with a second preset weight in response to the difference being smaller than or equal to a preset difference threshold, wherein the first preset weight is less than the second preset weight;
perform at least one of increasing the first preset weight and decreasing the second preset weight in response to the difference being greater than the preset difference threshold, and obtain the target color by calculating a sum of a third value obtained by weighting the preset standard face color with the increased first preset weight or the original first preset weight and a fourth value obtained by weighting the mean color value with the decreased second preset weight or the original second preset weight.

12. The electronic device according to claim 8, wherein the processor is configured to execute the instructions to:
determine the first face region that does not contain the hair from the target image according to the first face mask image;
perform rendering on pixels in the first face region according to the target color.

13. The electronic device according to claim 8, wherein the processor is configured to execute the instructions to:
obtain key facial points of the target image, and determine a second face mask image that contains hair according to the key facial points;
determine a second face region that contains hair from the target image according to the second face mask image;
perform rendering on pixels in the second face region according to the target color.

14. The electronic device according to claim 8, wherein the processor is configured to execute the instructions to:
obtain a target color of a previous frame image of a k^{th} frame image;
perform weighted summation on a target color of the k^{th} frame image and the target color of the previous frame image of the k^{th} frame image to obtain a color value;
perform rendering on the pixels in the face region of the target image according to the color value.

15. A non-transitory computer-readable storage medium, having stored therein instructions that, when executed by a processor of an electronic device, cause the electronic device to:
determine a first face mask image that does not contain hair from a target image, and obtain a first face region that does not contain hair from the target image according to the first face mask image;
fill a preset grayscale color in the target image outside the first face region to generate an image to be sampled in a preset shape;
perform down-sampling on the image to be sampled to obtain sampling results, and obtain one or more remaining sampling results by removing one or more sampling results in which a color is the preset grayscale color from the sampling results;
obtain a target color by calculating a mean color value of the one or more remaining sampling results and performing weighted summation on a preset standard face color and the mean color value;
perform rendering on pixels in a face region of the target image according to the target color.

16. The non-transitory computer-readable storage medium according to claim 15, wherein the instructions, when executed by the processor of the electronic device, cause the electronic device to:
calculate a mean value of color values in a same color channel in each remaining sampling result to obtain a mean color value corresponding to each color channel;
obtain a target color of each color channel by performing weighted summation on the mean color value corresponding to the color channel and a color value of a corresponding color channel in the standard face color.

17. The non-transitory computer-readable storage medium according to claim 15, wherein the instructions, when executed by the processor of the electronic device, cause the electronic device to:
calculate a mean color value of each remaining sampling result;
calculate a difference between the mean color value and a preset color threshold;
obtain the target color by calculating a sum of a first value obtained by weighting the preset standard face color with a first preset weight and a second value obtained by weighting the mean color value with a second preset weight in response to the difference being smaller than or equal to a preset difference threshold, wherein the first preset weight is less than the second preset weight;
perform at least one of increasing the first preset weight and decreasing the second preset weight in response to the difference being greater than the preset difference threshold, and obtain the target color by calculating a sum of a third value obtained by weighting the preset standard face color with the increased first preset weight or the original first preset weight and a fourth value obtained by weighting the mean color value with the decreased second preset weight or the original second preset weight.

18. The non-transitory computer-readable storage medium according to claim 15, wherein the instructions, when executed by the processor of the electronic device, cause the electronic device to:
determine the first face region that does not contain the hair from the target image according to the first face mask image;
perform rendering on pixels in the first face region according to the target color.

19. The non-transitory computer-readable storage medium according to claim 15, wherein the instructions, when executed by the processor of the electronic device, cause the electronic device to:
obtain key facial points of the target image, and determine a second face mask image that contains hair according to the key facial points;
determine a second face region that contains hair from the target image according to the second face mask image;
perform rendering on pixels in the second face region according to the target color.

20. The non-transitory computer-readable storage medium according to claim 15, wherein the instructions, when executed by the processor of the electronic device, cause the electronic device to:
obtain a target color of a previous frame image of a k^{th} frame image;
perform weighted summation on a target color of the k^{th} frame image and the target color of the previous frame image of the k^{th} frame image to obtain a color value;
perform rendering on the pixels in the face region of the target image according to the color value.
